(19) United States
(12) Patent Application Publication
(10) Pub. No.: US 2025/0365257 A1
(43) Pub. Date: Nov. 27, 2025

(54) SYSTEMS AND METHODS FOR AUTONOMOUS AD HOC GROUP OPERATIONS

(71) Applicant: Wells Fargo Bank, N.A., San Francisco, CA (US)

(72) Inventors: Jenny Tao, San Francisco, CA (US); Elizabeth Mellers, San Francisco, CA (US)

(21) Appl. No.: 18/672,919

(22) Filed: May 23, 2024

(51) Int. Cl. H04L 51/046; G06F 21/32

(52) U.S. Cl. CPC H04L 51/046; G06F 21/32

(57) ABSTRACT

Systems, apparatuses, methods, and computer program products are disclosed for establishing an ad hoc group and performing autonomous ad hoc group operations. An example method includes creating an ad hoc digital representation and selecting an invitation region to transmit an ad hoc group invitation to devices associated with individuals within the invitation region. The example method further includes receiving response decisions from the devices associated with the individuals within the invitation region and performing a digital authentication operation to authenticate devices for which the response decisions indicate acceptance of the invitation. The example method further includes adding authenticated devices to the ad hoc group and performing autonomous group operations. The autonomous group operations may comprise at least one or more of a group message broadcast, a group fund transaction, a group member geolocation tracking, a group member request handling, or a group feedback collection.

### BACKGROUND

A traditional group may include group organizers and other group members. These groups may be formed for a common purpose and are typically led by group organizers. The group may also include group members who may be required to attentively coordinate with the group organizers such that group operations may be completed successfully.

### BRIEF SUMMARY

As described above, traditional groups may be created for a common purpose, such as for a school field trip, a company event, an award ceremony, a wedding dinner party, etc. These groups may include one or more group organizers and a plurality of group members. Typically, group organizers manage responsibility and operations of the group such as by inviting managing group membership, sending group notifications, collecting group funds, distributing group assets (e.g., tickets, certificates, gifts, etc.), and handling group member requests.

Traditionally, the group organizers perform most group operations manually which may require a thorough planning in advance, which may be time-consuming especially for a large group. At the same time, group members must coordinate with group organizers before, during, and even after the group event so that all group operations may be completed successfully.

Similar to a traditional group, an ad hoc group is also created for a common purpose and may include one or more group organizers and a plurality of group members. However, in order to accommodate for the fast-pacing modern lifestyles and constantly changing schedules and requirements, an ad hoc group does not go through extensive prior planning like in a traditional group. For example, each ad hoc group member may join or leave the ad hoc group at any time, choose different group activities alone or with any other group members, and have different spending capabilities and limitations. Although ad hoc groups provide flexibility to their members, this poses a challenge to ad hoc group organizers tasked with establishing and managing such a group. For example, when establishing an ad hoc group, the group organizers may invite a list of individuals through mail, phone calls, emails, or text messages and then formulate a list of the group members after receiving confirmations, which may take days or even weeks to complete. The group organizers then must consistently manage the list, such as when an existing group member withdraws from the group, or a new individual joins the group at a later time. In particular, ad hoc group organizers may need to create a corresponding member profile for each group member that includes one or more payment methods, a daily expense limit, a food restriction, a health condition, and an emergency contact, and further, must update the member profile when a change is requested (e.g., a different payment method). As another example, when a fund collection is needed within an ad hoc group (e.g., to purchase aquarium tickets for a group of elementary school students), the group organizers may need to count the total number of group members at the venue, collect funds manually from each group member, calculate the total amount of the collected funds, purchase tickets at the ticket booth, and manually distribute the tickets to each group member. This fund collection process may become more complicated when the group members are allowed to choose different ticket options (e.g., an aquarium ticket including a 3-D movie, an aquarium ticket without including a 3-D movie but a meal, etc.). Furthermore, each group member is required to attentively coordinate with the group organizers to select a ticket option, make a payment for the ticket, and obtain the ticket. This traditional process is time-consuming and burdensome for organizers and members alike, thus making it undesirable and impractical, especially for large ad hoc groups.

Therefore, it is essential to streamline and automate the ad hoc group operations to offload burdens from both group organizers and group members. Embodiments described herein allow for the automatic establishment of ad hoc groups with minimal human intervention. In addition, embodiments described herein provide for a more secure group formation and management by automatically verifying the identities of individuals (e.g., using mobile drive license (mDL)) intending to join the ad hoc group. Embodiments described herein may further streamline group management activities by automatically processing requests to join or leave the group, change a payment method, or attend a particular group activity at any random time. Additionally, ad hoc group organizers may collect group funds autonomously using pre-determined payment methods such that the funds may be collected in real-time. In some embodiments, indicia of payment transactions, digital tickets, digital receipts, or the like may automatically be distributed to the group members after making a purchase with a merchant. Furthermore, all group operations may be stored automatically such that they may be used to resolve any future disputes and/or for audit purposes. As such, embodiments described herein may significantly reduce the time and effort required for the ad hoc group organizers so that they may simply monitor the ad hoc group operations and occasionally handle special or urgent situations when needed. The ad hoc group members may spend less time coordinating with the group organizers so that more time may be spent on attending group activities. A traditional group managed manually by one or more group organizers is impossible to perform those streamlined and automated group operations described above. In addition, a manually managed group is more error-prone, which may result in more fraudulence, disputes and even serious security concerns.

In contrast to a traditional group managed manually, example embodiments described herein provide an ad hoc group organizer system to perform autonomous ad hoc group operations. The ad hoc group organizer system may first establish an ad hoc group by creating an ad hoc group digital representation. The ad hoc group digital representation may be one of a text message, an interactive image, a uniform resource locator (URL), a web page, or a quick response (QR) code. In some embodiments, the ad hoc group organizer system may further select an invitation region to send an ad hoc group invitation to devices associated with individuals within the invitation region and the ad hoc group invitation may include the ad hoc group digital representation. The ad hoc group organizer system may further receive response decisions from the devices associated with the individuals within the invitation region and perform a digital authentication operation to authenticate devices for which the response decisions indicate acceptance of the invitation. The digital authentication operation may use a mDL associated with the devices. In some embodiments, the mDL associated with each of the devices may include either a digital identification for a corresponding guardian individual or a digital identification of a guardian linked with a corresponding minor individual. After performing the digital authentication operation, the ad hoc group organizer system may further add authenticated devices to the ad hoc group and start to perform autonomous group operations when needed. For example, autonomous group operations may include broadcasting group messages or group fund transactions, managing group member geolocation tracking, handling group member request, or collecting group feedback. In some embodiments, the ad hoc group organizer system may perform the group fund transaction by first determining group fund transaction options of one or more group members. The group fund transaction options include a set of authorized payment transaction types, a set of approved funding accounts, a one-time fund transaction amount limit, a daily total fund transaction amount limit, and/or a daily fund transaction frequency limit. After determining the group fund transaction options of the one or more group members, the ad hoc group organizer system may generate a group fund transaction event within the ad hoc group. The ad hoc group organizer system may further cause completion of a transaction with a merchant based on the group fund transaction event, and finally the ad hoc group organizer system may provide indicia of completion of the transaction to the group members.

Accordingly, the present disclosure sets forth systems, methods, and apparatuses that perform autonomous ad hoc group operations. There are many advantages of these, and other embodiments described herein over the traditional group managed manually described above. For instance, example embodiments are capable of establishing an ad hoc group automatically regardless of the size of the group and modifying the ad hoc group at any time with minimal human intervention. Furthermore, by leveraging the mDL to provide digital identification of users, example embodiments described herein verify each individual intending to join the ad hoc group such that the integrity of the ad hoc group remains secure. This is particularly important as ad hoc group members may automatically join and leave the ad hoc group in real-time. Furthermore, the ability to join and/or leave the ad hoc group at any time alleviates burdens on both group organizers and group members such because they are not required to perform any extensive prior planning, which may be time-consuming and resource-intensive for all involved parties.

In addition, the example embodiments are capable of performing all ad hoc group operations autonomously, which ensures real-time and accurate operations. For example, a group fund collection may happen in real-time at the venue. Example embodiments described herein ensure that the fund amounts are calculated accurately thus avoiding human mistakes, and different purchase options may be accommodated easily. The example embodiments may also record all the group operations. Therefore, in case of any discrepancy is identified, the record may be easily retrieved to initiate an audit process.

Furthermore, example embodiments described herein provide great flexibility and high security to the ad hoc group. For example, within the ad hoc group, an unlimited number of group activities may be handled simultaneously without overwhelming the group organizers. The group activities may be customized for any subset of group members. The group organizers may track each group member's geolocation and activity in real time, receive alerts and handle emergent situations promptly. Therefore, the example embodiments significantly reduce security concerns especially for ad hoc groups including young children and elders.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for autonomous ad hoc group operations.

FIG. 2 illustrates a schematic block diagram of example circuitry embodying an ad hoc group organizer system device that may perform various operations in accordance with some example embodiments described herein.

FIG. 3 illustrates a schematic block diagram of example circuitry embodying an ad hoc group primary member device and/or an ad hoc group minor member device that may perform various operations in accordance with some example embodiments described herein.

FIG. 4 illustrates an example flowchart for establishing an ad hoc group, in accordance with some example embodiments described herein.

FIG. 5 illustrates an example flowchart for performing group fund transaction, in accordance with some example embodiments described herein.

FIG. 6A illustrates an example flowchart for determining group fund transaction options, in accordance with some example embodiments described herein.

FIG. 6B illustrates an example flowchart for generating a group fund transaction event, in accordance with some example embodiments described herein.

FIG. 6C illustrates an example flowchart for providing indicia of a transaction, in accordance with some example embodiments described herein.

FIG. 7 illustrates another example flowchart for establishing an ad hoc group, in accordance with some example embodiments described herein.

FIG. 8 illustrates another example flowchart for performing a group fund transaction, in accordance with some example embodiments described herein.

FIG. 9A illustrates an example flowchart for selecting group fund transaction options, in accordance with some example embodiments described herein.

FIG. 9B illustrates an example flowchart for monitoring a group fund transaction event, in accordance with some example embodiments described herein.

FIG. 9C illustrates an example flowchart for receiving indicia indicative of completion of a transaction, in accordance with some example embodiments described herein.

FIG. 10 illustrates a swim lane diagram with example operations that may be performed by components of the environment depicted in FIG. 1, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “smart mobile wallet” refers to a digital application or a digital service which allows users to securely store, manage, and transact with various forms of digital currencies and payment methods using a mobile device, such as a smart mobile phone or a tablet. The smart mobile wallet may store digital identifications associated with a respective user (e.g., an mDL), personal information (e.g., user preferences, transaction history, security settings, health conditions, food restrictions, etc.), payment methods (e.g., credit/debit card information, customer loyalty card information, digital coupons, etc.), cryptocurrencies (Bitcoin, Ethereum, Litercoin, etc.), personal items (e.g., boarding passes, event tickets, etc.), and private keys for securely accessing and managing the stored personal information, digital assets and payment methods. The smart mobile wallet provides a convenient, secure and contactless method for users to store personal information and make payments either in-store or online.

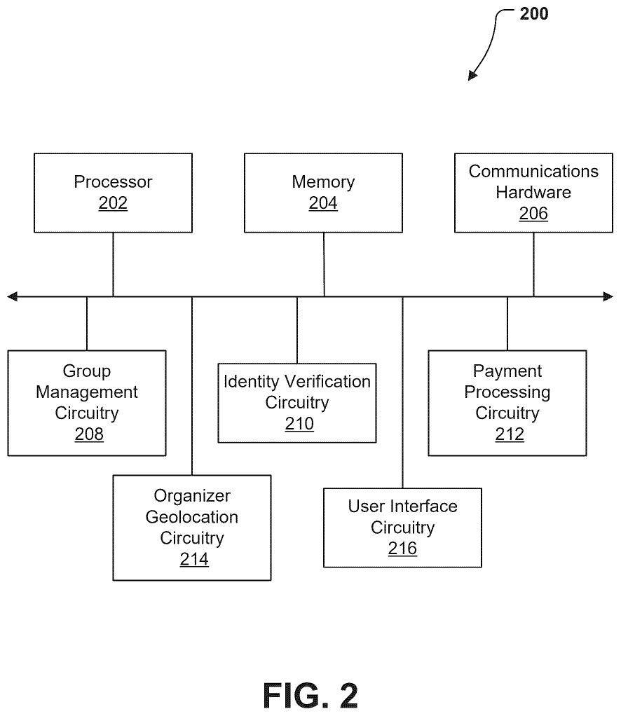

The terms “mobile drive license” and “mDL” refer to various mobile (e.g., digital) identity credential types associated with a respective user. An mDL may be a digital version of a physical legal credential (e.g., a driver's license) associated with a respective user and may comprise and/or be associated with the same data as the legal credential. An mDL may be an electronically managed data structure configured to be accessed, processed, and/or otherwise utilized by an identity authentication device (e.g., identity verification circuitry 210, as shown in FIG. 2) for various user authentication processes. An mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating issuing authority (IA) data (e.g., cryptographic key information and/or identifying data associated with an originating IA).

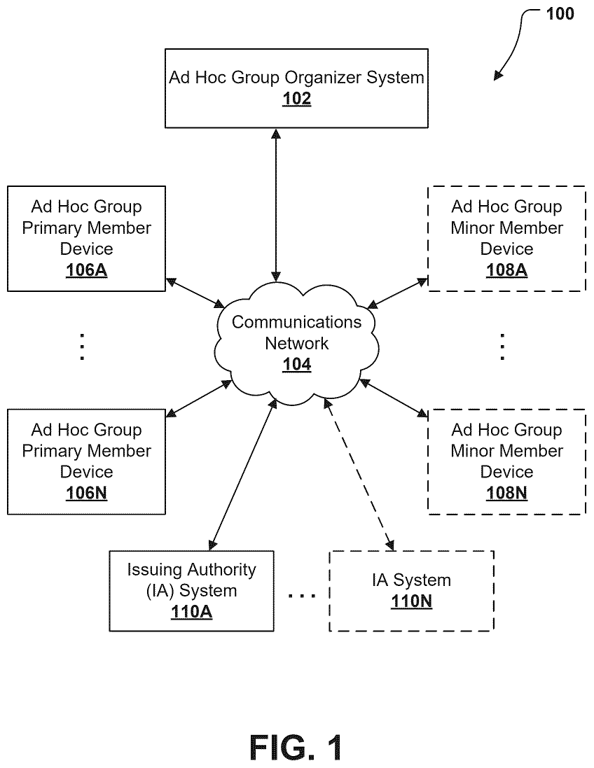

One or more portions of credential data related to the mDL may be retrieved in real time, or near-real time, during a transaction associated with the user (e.g., an online transaction requiring user authentication, user age verification, and/or the like). Additionally, or alternatively, once an mDL is issued to a user by a respective IA, the mDL may be stored locally on a user device associated with the user (e.g., ad hoc group primary member device 106A-106N or ad hoc group minor member device 108A-108N, as shown in FIG. 1) such that the mDL may be used without relying on a communications network (e.g., communications network 104). Additionally, or alternatively, in some embodiments, an mDL may be stored in a smart mobile wallet associated with the user, and the mDL may be accessed and/or utilized by the user or another authorized device via the smart mobile wallet application. In some embodiments, an mDL may not be stored in the smart mobile wallet associated with the user, and the mDL may be accessed and/or utilized by the user or another authorized device via different mobile applications (e.g., a financial institute application, a standalone third-party application, etc.). In some embodiments, an mDL may be installed on multiple user devices for use by a primary user (e.g., a parent, an adult, a caretaker, a guardian) and a minor user (e.g., a child, an elderly individual, or the like).

The term “group organizer” refers to an individual managing an ad hoc group. These individuals may or may not attend the group event. A group organizer may be associated with certain privileges regarding the ad hoc group operations. For example, group organizers may be associated with privileges that allow them to access information of all the ad hoc group members. In some embodiments, the term group organizer may also refer to the devices associated with the group organizers. The devices associated with the group organizers may be configured to perform various functions for autonomous ad hoc group operations as described herein. The devices of the group organizers may be configured with access credentials that allow the group organizers to manage or access certain information pertaining to the ad hoc group.

The term “group member” refers to an individual attending an ad hoc group event. Group members do not manage group operations but instead, participate in some or all of the group activities of the ad hoc group. Group members may also be associated with privilege, but these privileges may be different privileges than privileges associated with group organizers. For example, group members may only communicate with the group organizers. In some embodiments, the term group member may also refer to the devices associated with the group members. The devices associated with the group members may be configured to perform various functions for autonomous ad hoc group operations as described herein. The devices of the group organizers may be configured with access credentials that allow the group members to interact with the ad hoc group and/or group organizers.

### System Architecture

Example embodiments described herein may be implemented using any of a variety of computing devices or servers. To this end, FIG. 1 illustrates an example environment 100 within which various embodiments may operate. As illustrated, an ad hoc group organizer system 102 may receive and/or transmit information via communications network 104 (e.g., the Internet) with any number of other devices, such as one or more of ad hoc group primary member devices 106A-106N, one or more ad hoc group minor member devices 108A-108N, and/or issuing authority (IA) systems 110A-110N.

The ad hoc group organizer system 102 may be implemented as one or more computing devices or servers, which may be composed of a series of components. Particular components of the ad hoc group organizer system 102 are described in greater detail below with reference to apparatus 200 in connection with FIG. 2. Although only one ad hoc group organizer system 102 is illustrated in FIG. 1, the present disclosure contemplates that more than one ad hoc group organizer system 102 may be present in some embodiments, such as when the ad hoc group includes more than one ad hoc group organizers.

The one or more ad hoc group primary member devices 106A-106N and the one or more ad hoc group minor member devices 108A-108N may be embodied by any computing devices known in the art. The ad hoc group primary member devices 106A-106N may be associated with primary group members who may own an mDL. These individuals may make decisions for themselves for any group operations and activities. On the other hand, the ad hoc group minor member devices 108A-108N are associated with minor group members who may utilize a guardian's mDL and may require authorization from the guardian for group operations and activities. The ad hoc group primary member devices 106A-106N may comprise an indicator or flag to indicate that the owner of the device is a primary user and may further indicate the corresponding minor user and/or ad hoc minor member device 108A-108N. The ad hoc group minor member devices 108A-108N may comprise a different indicator or flag to indicate that the owner of the device is a minor. The group operations and activities may be operated differently with the ad hoc group primary member devices 106A-106N or the ad hoc group minor member devices 108A-108N. In some embodiments, the guardians for the minor group members may also be invited to join the ad hoc group to coordinate with group operations and activities. The one or more ad hoc group primary member device 106A-106N and the one or more ad hoc group minor member device 108A-108N need not themselves be independent devices but may be peripheral devices communicatively coupled to other computing devices.

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the ad hoc group organizer system 102 in compliance with various standards set forth by the American Association of Motor Vehicle Administrators (AAMVA). Additionally, or alternatively, in some embodiments, an mDL may be administered, managed, employed, and/or otherwise utilized by the ad hoc group organizer system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally or alternatively, once an mDL is issued to a user by a respective IA (e.g., by way of a corresponding IA system 110A), the mDL may be stored locally on a user device associated with the user (e.g., ad hoc group primary member device 106A-106N and/or ad hoc group minor member device 108A-108N) such that the mDL may be used without relying on a communications network (e.g., communications network 104).

In some examples, an IA may provision an mDL to a particular user device (e.g., ad hoc group primary member device 106A-106N and/or ad hoc group minor member device 108A-108N) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., ad hoc group primary member device 106A-106N and/or ad hoc group minor member device 108A-108N) also enables the ad hoc group organizer system 102 and/or an IA system of an IA (e.g., IA system 110A) to verify that the intended user of the mDL is in possession of the mDL. Further still, associating an mDL with a particular device (e.g., ad hoc group primary member device 106A-106N and/or ad hoc group minor member device 108A-108N) also ensures the safe transfer of sensitive credential data to and/or from the intended user of the mDL. In various examples, a user may store multiple copies of an mDL on multiple user devices (e.g., ad hoc group primary member device 106A-106N and/or ad hoc group minor member device 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

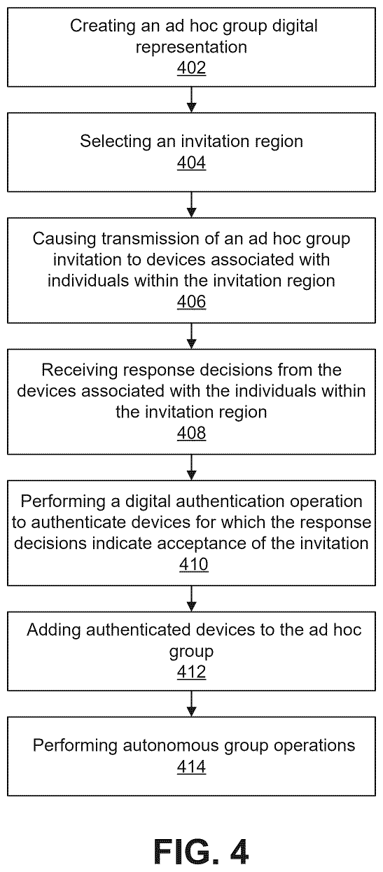

Additionally, an mDL may be associated with various cryptographic key information (e.g., public/private key pair information) that may be utilized by the ad hoc group organizer system 102 to authenticate an originating IA that issued the mDL, verify one or more portions of credential data associated with an mDL, and/or facilitate various mDL-based transactions (e.g., FLSA operations, retail purchase transactions, user authentication protocols, mDL data queries) for a user associated with the mDL. For example, an IA associated with a respective IA system 110A may be associated with a unique public key that may be utilized by the ad hoc group organizer system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the ad hoc group organizer system 102 will be described in greater detail herein with reference to FIGS. 4-10.

### Example Implementing Apparatuses

The ad hoc group organizer system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-10. As illustrated in FIG. 2, the apparatus 200 may include processor 202, memory 204, communications hardware 206, group management circuitry 208, identity verification circuitry 210, payment processing circuitry 212, organizer geolocation circuitry 214, and user interface circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a group management circuitry 208 that may be configured to create an ad hoc group digital representation for establishing an ad hoc group and performs autonomous group operations. The group management circuitry 208 may utilize processor 202, memory 204, or any other hardware component included in the apparatus 200 to perform these operations, as described in connection with FIGS. 4-10 below. The group management circuitry 208 may further utilize communications hardware 206 to gather data from a variety of sources (e.g., ad hoc group primary member device 106A through 106N or ad hoc group minor member device 108A through 108N, as shown in FIG. 1), and/or exchange data with a user, and in some embodiments may utilize processor 202 and/or memory 204 to create an ad hoc group digital representation for establishing an ad hoc group and perform autonomous group operations. The ad hoc group digital representation may be one of a text message, an interactive image, a URL, a web page, or a QR code. The autonomous group operations may comprise at least one or more of a group message broadcast, a group fund transaction, a group member geolocation tracking, a group member request handling, or a group feedback collection. When performing a group fund transaction, the group management circuitry 208 may first determine the group fund transaction options available for the ad hoc group. The group fund transaction options comprise at least one or more of a set of authorized payment transaction types, a set of approved funding accounts, a one-time fund transaction amount limit, a daily total fund transaction amount limit, or a daily fund transaction frequency limit. By leveraging the communications hardware 206, the group management circuitry 208 may further transmit a group fund transaction options selection request to one or more group members and receive the group fund transaction options of the one or more group members. In some embodiments, the group management circuitry 208 may further perform a verification operation on the group fund transaction options selected by the one or more group members and request to reselect the group fund transaction options if the verification operation indicates that the selected group fund transaction options are invalid. After determining the group fund transaction options of one or more group members, the group management circuitry 208 may further generate a group fund transaction event within the ad hoc group. During the group fund transaction event, the group management circuitry 208 may execute a first group fund transaction and if the first group fund transaction is not successful for one or more group members, the group management circuitry 208 may execute a second group fund transaction for the one or more group members. When the second group fund transaction is not successful for one or more group members, the group management circuitry 208 may further remove the one or more group members from the ad hoc group. When a transaction is completed based on the group fund transaction event, the group management circuitry 208 may generate itemized indicia of completion of the transaction and provide the itemized indicia to one or more group members through the communications hardware 206. In some embodiments, the group management circuitry 208 may further initiate an audit process when a transaction discrepancy is identified.

In addition, the apparatus 200 further comprises an identity verification circuitry 210 that performs a digital authentication operation to authenticate devices indicating acceptance of the invitation to join an ad hoc group. The identity verification circuitry 210 may utilize processor 202, memory 204, or any other hardware component included in the apparatus 200 to perform these operations, as described in connection with FIGS. 4-10 below. The identity verification circuitry 210 may further utilize communications hardware 206 to gather data from a variety of sources (e.g., ad hoc group primary member device 106A through 106N or ad hoc group minor member device 108A through 108N, as shown in FIG. 1), and/or exchange data with a user, and in some embodiments may utilize processor 202 and/or memory 204 to perform the digital authentication operation. In some embodiments, the digital authentication operation may use an mDL associated with the devices (e.g., ad hoc group primary member device 106A through 106N or ad hoc group minor member device 108A through 108N, as shown in FIG. 1), wherein the mDL associated with each of the devices comprises either a digital identification for a corresponding primary user or a digital identification of a guardian linked with a corresponding minor individual. The identity verification circuitry 210 may request or directly access the mDL information stored in the ad hoc group primary member device 106A-106N or ad hoc group minor member device 108A-108N and verify whether the information on the mDL (e.g., name, age, address, mDL issuing date, mDL expiration date, etc.) is consistent with the primary individual or the guardian of the minor individual intending to join the ad hoc group. In some embodiments, the mDL may be stored in a smart mobile wallet and the identity verification circuitry 210 may further access the personal information stored in the smart mobile wallet and make comparison with the information retrieved from the mDL for verification.

In addition, the apparatus 200 further comprises a payment processing circuitry 212 that configured to cause completion of a payment transaction with a merchant based on the group fund transaction event (e.g., purchasing tickets with aquarium, ordering meals with a restaurant, etc.). The payment processing circuitry 212 may utilize processor 202, memory 204, or any other hardware component included in the apparatus 200 to perform these operations, as described in connection with FIGS. 4-10 below. The payment processing circuitry 212 may further utilize communications hardware 206 to gather data from a variety of sources (e.g., ad hoc group primary member device 106A through 106N or ad hoc group minor member device 108A through 108N, as shown in FIG. 1), and/or exchange data with a user, and in some embodiments may utilize processor 202 and/or memory 204 to process a payment transaction with a merchant. The payment processing circuitry 212 may perform one transaction with the merchant for the entire ad hoc group and obtain one payment confirmation. In some embodiments, the payment processing circuitry 212 may perform one transaction for each group member with the merchant, thus, a payment confirmation for each group member may be obtained.

In addition, the apparatus 200 further comprises an organizer geolocation circuitry 214 that selects an invitation region to establish an ad hoc group. The organizer geolocation circuitry 214 may utilize processor 202, memory 204, or any other hardware component included in the apparatus 200 to perform these operations, as described in connection with FIGS. 4-10 below. The organizer geolocation circuitry 214 may further utilize communications hardware 206 to gather data from a variety of sources (e.g., ad hoc group primary member device 106A through 106N or ad hoc group minor member device 108A through 108N, as shown in FIG. 1), and/or exchange data with a user, and in some embodiments may utilize processor 202 and/or memory 204 to select an invitation region to establish an ad hoc group. The organizer geolocation circuitry 214 may determine geographically an invitation region specified by the ad hoc group organizers (e.g., a school, a company, a city district, center geographical coordinates with a radius, etc.). Only the devices located within the invitation region determined by the organizer geolocation circuitry 214 may receive the invitation to join the ad hoc group. The devices may also need to have an ad hoc group application or the like pre-installed to receive the invitation. In some embodiments, the organizer geolocation circuitry 214 may be further used to track the geolocations of the ad hoc group members during the group event for security purposes.

Further, the apparatus 200 may comprises a user interface circuitry 216 that allows the ad hoc group organizers to add the authenticated devices to the ad hoc group selectively. The user interface circuitry 216 may utilize processor 202, memory 204, or any other hardware component included in the apparatus 200 to perform these operations, as described in connection with FIGS. 4-10 below. The user interface circuitry 216 may further utilize communications hardware 206 to gather data from a variety of sources (e.g., ad hoc group primary member device 106A through 106N or ad hoc group minor member device 108A through 108N, as shown in FIG. 1), and/or exchange data with a user, and in some embodiments may utilize processor 202 and/or memory 204 to select an invitation region to add the authenticated devices to the ad hoc group selectively. In some embodiments, the ad hoc group organizers may manually examine or modify the ad hoc group through the user interface circuitry 216 when needed. In some embodiments, the ad hoc group organizer may send group notifications, handle different requests from group members through the user interface circuitry 216. The user interface circuitry 216 may comprise one or more of a keyboard, pointing device, touchscreen, microphone with speech recognition interface, camera with gesture-based interface, or other input device capably of receiving various different user inputs. In addition, the user interface circuitry 216 may comprise a display device including one or more of a screen with graphical user interface (GUI), speaker, light emitting diode (LED), haptic technology device, or other output device capable of rendering information to a user.

Although components 202-216 are described in part using functional language, it will be understood that the particular implementations necessarily include the use of particular hardware. It should also be understood that certain of these components 202-216 may include similar or common hardware. For example, the group management circuitry 208, identity verification circuitry 210, payment processing circuitry 212, organizer geolocation circuitry 214, and user interface circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the group management circuitry 208, identity verification circuitry 210, payment processing circuitry 212, organizer geolocation circuitry 214, and user interface circuitry 216 may leverage processor 202, memory 204, or communications hardware 206 as described above, it will be understood that any of group management circuitry 208, identity verification circuitry 210, payment processing circuitry 212, organizer geolocation circuitry 214, and user interface circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that group management circuitry 208, identity verification circuitry 210, payment processing circuitry 212, organizer geolocation circuitry 214, and user interface circuitry 216 comprise particular machinery designed for performing the functions described herein in connection with such elements of apparatus 200.

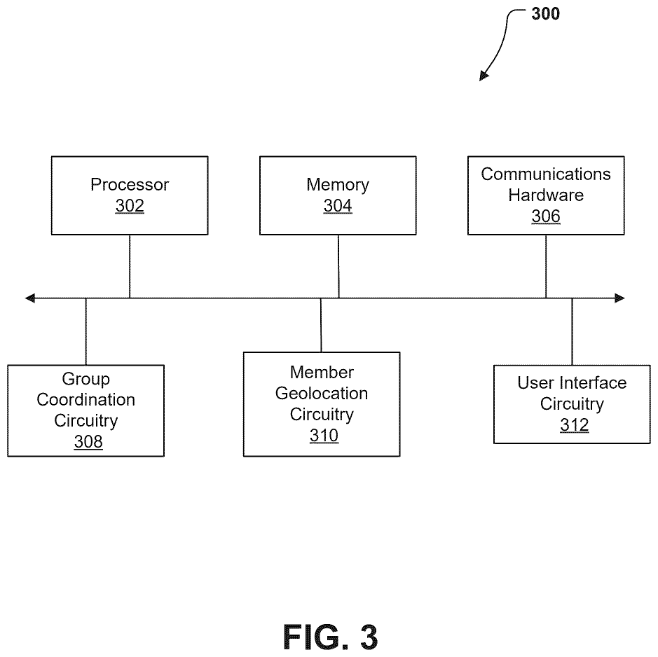

As illustrated in FIG. 3, an apparatus 300 is shown that represents an example ad hoc group primary member device (e.g., any of ad hoc group primary member device 106A-106N) or an example ad hoc group minor member device (e.g., any of ad hoc group minor member device 108A-108N). The apparatus 300 includes processor 302, memory 304, and communications hardware 306, each of which is configured to be similar to the similarly named components described above in connection with FIG. 2.

However, the apparatus 300 may also include group coordination circuitry 308, which includes hardware components designed for coordinating the group operations. The group coordination circuitry 308 may utilize processor 302, memory 304, or any other hardware component included in the apparatus 300 to perform these operations, as described in connection with FIGS. 4-10 below. The group coordination circuitry 308 may further utilize communications hardware 306 to coordinate the group operations or may otherwise utilize processor 302 and/or memory 304 to coordinate the group operations. The group coordination circuitry 308 may coordinate with the digital authentication operation to provide required information on the mDL to the ad hoc group organizer system 102. The group coordination circuitry 308 may further coordinate with the group operations by responding to different requests from the ad hoc group organizer system 102. During a group fund transaction, the group coordination circuitry 308 may select group fund transaction options based on the preference set by the respective group member, monitor fund transactions, verify whether the itemized indicia for the transaction is accurate, and report a transaction discrepancy to the ad hoc group organizer system 102 for initiating an audit process. In some embodiments, by leveraging the user interface circuitry 312, the group coordination circuitry 308 may alert the respective group member for group notifications, required actions, and group operation issues (e.g., payment method issue, transaction discrepancy, etc.).

In addition, the apparatus 300 may also include member geolocation circuitry 310, which includes hardware components designed for communicatively coupling with a satellite- based radio navigation system (e.g., global positioning system (GPS)) and/or a cellular network to determine the current location for the apparatus 300 (e.g., via GPS coordinates, radiolocation through triangulation between base station, or the like). The member geolocation circuitry 310 may utilize processor 302, memory 304, or any other hardware component included in the apparatus 300 to perform these operations, as described in connection with FIGS. 4-10 below. The member geolocation circuitry 310 may further utilize communications hardware 306 to communicate with navigation systems, cellular networks, and/or apparatus 200, or may otherwise utilize processor 302 and/or memory 304 to generate geolocation data representative of the current location of the apparatus 300. The geolocation data generated by the member geolocation circuitry 310 may be used to receive the ad hoc group invitation if the location is within the invitation region. During the ad hoc group operations, the ad hoc group organizer system 102 may request geolocation data generated by the member geolocation circuitry 310 to track the location of each group member for security purposes.

Further, the apparatus 300 may also include user interface circuitry 312, that allows the ad hoc group members to manually respond to the group requests received from the ad hoc group organizer system 102. The user interface circuitry 312 may utilize processor 302, memory 304, or any other hardware component included in the apparatus 300 to perform these operations, as described in connection with FIGS. 4-10 below. The user interface circuitry 312 may further utilize communications hardware 306 to manually respond to the group requests received from the ad hoc group organizer system 102 or may otherwise utilize processor 302 and/or memory 304 to manually respond to the group requests received from the ad hoc group organizer system 102. The user interface circuitry 312 may allow an individual to join an ad hoc group or an ad hoc group member to withdraw from the ad hoc group. The user interface circuitry 312 may further allow a group member to send a request to the ad hoc group organizer system 102 (e.g., change a payment option, join a group activity, make a ticket option selection, etc.). The user interface circuitry 312 may comprise one or more of a keyboard, pointing device, touchscreen, microphone with speech recognition interface, camera with gesture-based interface, or other input device capably of receiving various different user inputs. In addition, the user interface circuitry 312 may comprise a display device including one or more of a screen with graphical user interface (GUI), speaker, light emitting diode (LED), haptic technology device, or other output device capable of rendering information to a user.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Ad Hoc Group Organizer Operations

Turning to FIGS. 4-9C, example flowcharts are illustrated that contain example operations implemented by example embodiments described herein. The operations illustrated in FIGS. 4, 5, and 6A-6C may, for example, be performed by system device of the ad hoc group organizer system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, group management circuitry 208, identity verification circuitry 210, payment processing circuitry 212, organizer geolocation circuitry 214, and user interface circuitry 216, and/or any combination thereof. It will be understood that user interaction with the ad hoc group organizer system 102 may occur directly via communications hardware 206 or may instead be facilitated by a separate device (e.g., ad hoc group primary member device 106A through 106N or ad hoc group minor member device 108A through 108N, as shown in FIG. 1, which may in turn be embodied by an apparatus 300, which is shown and described in connection with FIG. 3), as shown in FIG. 1, and which may have similar or equivalent physical componentry facilitating such user interaction.

Turning first to FIG. 4, example operations are shown for establishing an ad hoc group. As shown by operation 402, the apparatus 200 may include means, such as processor 202, memory 204, communications hardware 206, group management circuitry 208, user interface circuitry 216, or the like, for creating an ad hoc group digital representation. The ad hoc group digital representation may be one of a text message, an interactive image, a URL, a web page, or a QR code. The ad hoc group digital representation may include or may link to a detailed description of the ad hoc group (e.g., schedule, location, activities, purchase requirements, etc.). The digital representation may allow group members or would-be group members (e.g., individuals who have not yet joined the ad hoc group) to have interact with the group via their devices. For example, the digital representation may be interacted with by an individual via their device such and may allow individuals to identify the purpose of the ad hoc group conveniently. Further, the ad hoc group digital representation may allow individuals to join the ad hoc group easily by operating directly with the digital representation (e.g., scanning the QR code, clicking the URL, etc). The group management circuitry 208 may create the ad hoc group digital representation using an ad hoc group software and/or application by using user interface circuitry 216. For example, the group management circuitry 208 may be configured to generate a QR code, hyperlink with the group URL, webpage, and/or the like using any suitable technique. The group management circuitry 208 may further store the digital representation in the memory 204 for future access of the group information.

As shown by operation 404, the apparatus 200 may include means, such as processor 202, memory 204, communications hardware 206, organizer geolocation circuitry 214, user interface circuitry 216, or the like, for selecting an invitation region. The organizer geolocation circuitry 214 may select an invitation region, which may be a bounded geographic area within which the ad hoc group may operate. In some embodiments, the boundaries of the invitation region may be customized by specified by the ad hoc group organizer such that customized shapes, areas, and/or boundaries may be contemplated. In some embodiments, the boundaries of the invitation region may be preset or configured by the group organizer or another entity. For example, a group organizer may select a point on a map or a geographical coordinate and may define a radius about that point or coordinates. As another example, the group organizer may interact with the map to draw custom boundaries. Alternatively, the boundaries of the invitation region may be defined by an address, coordinates, or other predefined boundaries. For example, an invitation region may be a school, a company, a city district, etc. In some embodiments, the group organizer may both use predefined boundaries and custom boundaries. For example, the group organizer may select a particular location associated with predefined coordinates, such as an aquarium, but may further refine the boundaries to be limited within the ticket or admission area. As such, the resulting invitation region may encompass only the geographic area associated with the ticket or admission area of the aquarium.

In some embodiments, the organizer geolocation circuitry 214 may first determine the current location of the ad hoc group organizers and display the location on a map through the user interface circuitry 216. The group organizers may further select a region based on the map displayed through the user interface circuitry 216. Based on the region selected by the group organizers, the organizer geolocation circuitry 214 may further determine the invitation region. Only the devices located within the invitation region determined by the organizer geolocation circuitry 214 may receive the invitation to join the ad hoc group.

As shown by operation 406, the apparatus 200 may include means, such as processor 202, memory 204, communications hardware 206, organizer geolocation circuitry 214, or the like, for causing transmission of an ad hoc group invitation to devices associated with individuals within the invitation region. In some embodiments, the broadcast may use wireless communications (e.g., Wi-Fi), Bluetooth communications, near-field communications (NFC), and/or the like. As such, devices within the invitation area may receive the ad hoc group invitation that may include the ad hoc group digital representation. As such, individuals within the invitation area may view the invitation to learn about the ad hoc group and may interact with the ad hoc group. In some embodiments, before transmitting the ad hoc group invitation, the communications hardware 206 may first request the geolocation data of each device and determine if the devices is located within the invitation region by leveraging the organizer geolocation circuitry 214. In some embodiments, the devices may also need to have an ad hoc group application or the like pre-installed to receive the invitation.

As shown by operation 408, the apparatus 200 may include means, such as processor 202, memory 204, communications hardware 206, organizer geolocation circuitry 214, or the like, for receiving response decisions from the devices associated with the individuals within the invitation region. The response decisions may indicate an intention to accept, reject or defer the ad hoc group invitation. In some embodiments, after receiving the response decisions to accept the invitation, the communications hardware 206 may further request the geolocation data of each device and determine if the device is located within the invitation region by leveraging the organizer geolocation circuitry 214. In an instance that the geolocation data indicates that the device is outside of the invitation region, the ad hoc group organizer may make a final determination of whether the individual associated with the device is allowed to join the ad hoc group.

As shown by operation 410, the apparatus 200 may include means, such as processor 202, memory 204, communications hardware 206, group management circuitry 208, identity verification circuitry 210, or the like, for performing a digital authentication operation to authenticate devices for which the response decisions indicate acceptance of the invitation. The identity verification circuitry 210 may perform the digital authentication operation by using an mDL associated with the device that provided the affirmative response. The mDL may include either a digital identification for a corresponding primary individual or a digital identification of a guardian linked with a corresponding minor individual. In some embodiments, the response decision from each device that accepts the ad hoc group invitation may include the mDL. Alternatively, the identity verification circuitry 210 may request the device to provide the mDL. In some embodiments, the identity verification circuitry 210 may request the device to provide only certain credential data of the mDL (e.g., name, age, address, mDL issuing date, mDL expiration date, etc.) or may obtain the credential data by accessing the mDL stored in the device directly. In some embodiments, the mDL may be a digital token. The identity verification circuitry 210 may perform the digital authentication operation for each device (e.g., any one of ad hoc group primary member devices 106A-106N and/or ad hoc group minor member devices 108A-108N).

In some embodiments, the identity verification circuitry 210 may transmit the mDL (e.g., digital token) to an IA system (e.g., IA system 110A). In particular, the group management circuitry 208 may leverage the communications hardware 206 to transmit the digital token to an IA system (e.g., IA system 110A) associated with the IA that provisioned the mDL to the corresponding user (e.g., a primary user or a guardian user associated with a minor user) such that the IA system (e.g., IA system 110A) may decrypt the cryptographic information comprised in the digital token. In this manner, the IA system (e.g., IA system 110A) may authenticate (e.g., verify) one or more portions of credential data associated with the mDL.

Responsive to providing the digital token to the IA, the communications hardware 206 may receive an mDL validity response. For example, the communications hardware 206 may receive the mDL validity response from the IA system (e.g., IA system 110A) associated with the IA that provisioned the mDL to the user (e.g., a primary user or a guardian user associated with a minor user). In various embodiments, the mDL validity response is generated based on the digital token associated with the user. In some examples, the mDL validity response indicates verified credential data associated with the mDL. Furthermore, in some examples, the mDL validity response may also indicate verified user device identification data related to the user device associated with the user (e.g., a corresponding ad hoc group primary member devices 106A-106N and/or ad hoc group minor member devices 108A-108N). Verified user device identification data may be indicative that the particular user device which provided the mDL is known and verified to be associated with the user or individual.

The identity verification circuitry 210 may then be configured to authenticate the user based on the mDL validity response. For example, the identity verification circuitry 210 may be configured to authenticate the requesting user (e.g., a primary user or a minor user) based on the verified credential data included in the mDL validity response received from the IA system (e.g., one of IA systems 110A-110N) and/or based on the verified user device identification data. In this manner, apparatus 200 may be configured to authenticate a requesting user requesting to become a group member of the ad hoc group based on the provided mDL and/or an associated device (e.g., any one of ad hoc group primary member devices 106A-106N and/or ad hoc group minor member devices 108A-108N).

In some embodiments, the group organizer may generate and utilize a required information set. This required information set may control what credential information is required to be verified for a primary user and/or guardian user prior to the user joining the ad hoc group. Thus, in some embodiments, the identity verification circuitry 210 may further verify whether the required credential information is verified for the requesting primary user or guardian user. In an instance that the verified credential information satisfies the required information set, the identity verification circuitry 210 may authenticate the requesting user. Otherwise, the identity verification circuitry 210 may not authenticate the requesting user.

In some embodiments, the response decision for a requesting user (e.g., the primary user and/or minor user) requesting to join the ad hoc group may also include candidate credential information. Candidate credential information may be credential information provided by the requesting user that has not yet been verified. Thus, in some embodiments, the identity verification circuitry 210 may compare the candidate credential information to the verified credential information to ensure a match. The identity verification circuitry 210 may determine whether the candidate credential information matches the verified credential information and in an instance the candidate credential information matches the verified credential information, the identity verification circuitry 210 may authenticate the requesting user. Otherwise, the identity verification circuitry 210 may not authenticate the requesting user. In some embodiments, the identity verification circuitry 210 may only make comparisons between provided candidate credential information and verified candidate credential information that corresponds to required credential information as defined by the required information set. That is, the user may provide additional candidate credential information that may be extraneous and therefore, does not need to be compared to verified credential information.

Regardless of the digital authentication operation performed, the identity verification circuitry 210 may generate a verification confirmation indicative that the requesting user has been added to the ad hoc group or a verification failure indicative that the requesting user could not be authenticated. In some embodiments, a requesting user may provide an updated response decision with updated information for a limited number of reattempts (e.g., five attempts) in an instance in which the requesting user could not be authenticated.

As shown by operation 412, the apparatus 200 may include means, such as processor 202, memory 204, communications hardware 206, group management circuitry 208, or the like, for adding authenticated devices to the ad hoc group. Once authenticated, the group management circuitry 208 may add an authenticated device to the ad hoc group. The group management circuitry 208 may create a group member profile for the group member within the ad hoc group and may further assign the associated device (e.g., any one of ad hoc group primary member devices 106A-106N and/or ad hoc group minor member devices 108A-108N) certain privileges such that the device may operate within the ad hoc group.

In some embodiments, the group management circuitry 208 may further request additional personal information from each new group member associated with the authenticated devices to update a corresponding group member profile. For example, a group member profile may include one or more payment methods, a daily expense limitation, a food restriction, a health condition, an emergency contact, etc. The group management circuitry 208 may allow the associated device to access this group member profile but may prevent other devices within the ad hoc group from accessing this group member profile. As such, the group member profile may only be viewable and/or accessible to the associated user (e.g., the primary user or minor user and guardian user) in addition to apparatus 200.

Finally, as shown by operation 414, the apparatus 200 includes means, such as processor 202, memory 204, communications hardware 206, group management circuitry 208, organizer geolocation circuitry 214, user interface circuitry 216, or the like, for performing autonomous group operations. Autonomous group operations may refer to operations offered to all group members currently enrolled within the ad hoc group. For example, autonomous group operations may include a group message broadcast, a group fund transaction, a group member geolocation tracking, a group member request handling, or a group feedback collection.

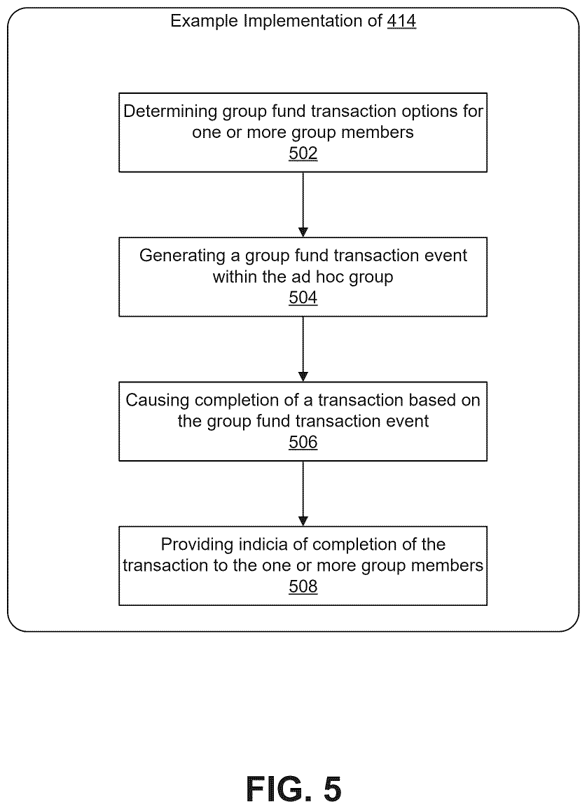

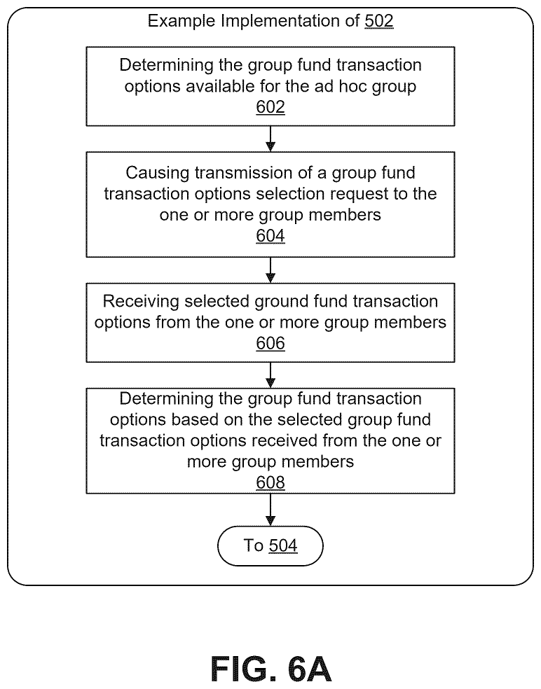

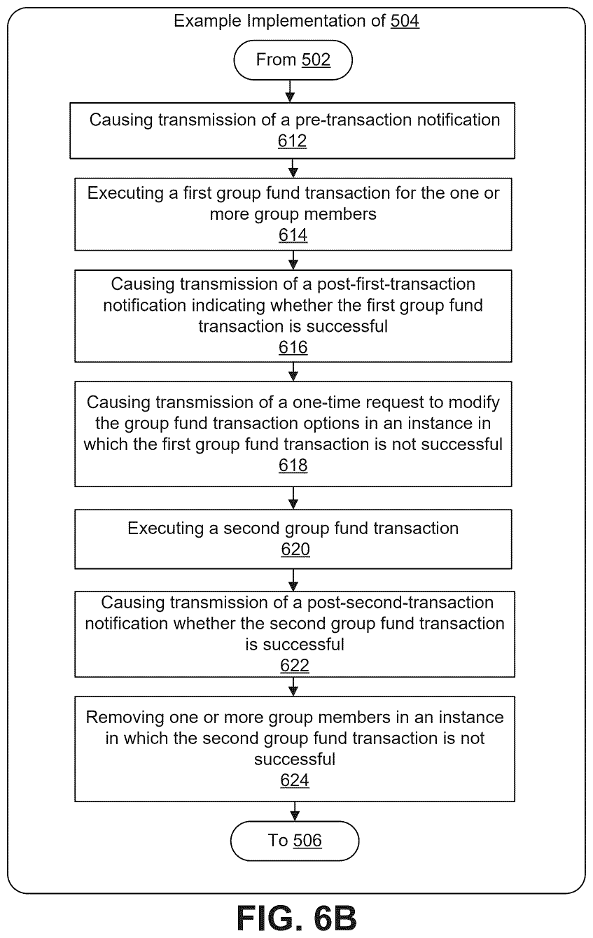

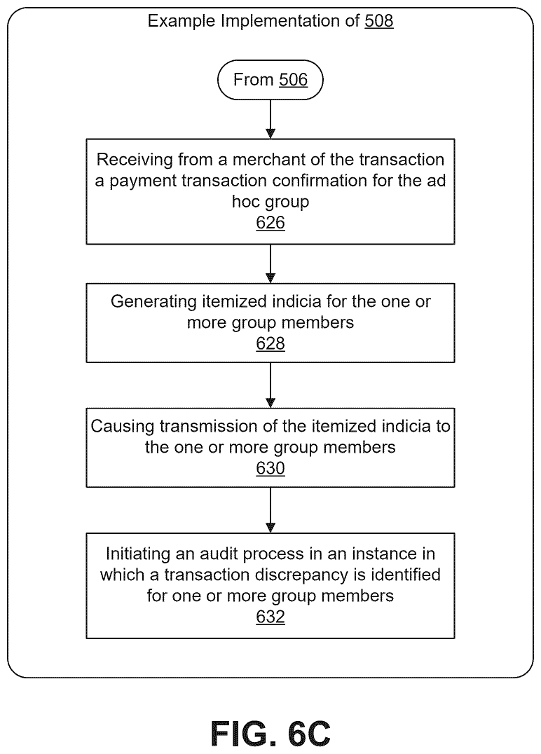

For group message broadcast, the group management circuitry 208 may create a group message and then cause transmission of the group message to all group members and receive acknowledgements by leveraging the communications hardware 206. For group member geolocation tracking, the group management circuitry 208 may request geolocation data from one or more group member devices (e.g., ad hoc group primary member device 106A through 106N or ad hoc group minor member device 108A through 108N) randomly or periodically through the communications hardware 206 and then analyse the geolocation data by leveraging the organizer geolocation circuitry 214. For group member request handling, the group management circuitry 208 may receive requests from one or more group members (e.g., change the payment option) and the requests may be displayed on the user interface circuitry 216. The group management circuitry 208 may further process the request based on the input from the group organizers through the user interface circuitry 216 and send a confirmation to the member devices through the communications hardware 206. For group feedback collection (e.g., after the group event), the group management circuitry 208 may cause transmission of a feedback request to the member devices, receive the feedback from the member devices through the communications hardware 206. The group management circuitry 208 may further save the feedback to the memory 204 for further analysis. The operations to facilitate a group fund transaction will be described in greater detail below in connection with FIGS. 5, and 6A-6C.

In some embodiments, operation 414 for a group fund transaction may be performed in accordance with the operations described by FIG. 5. Turning now to FIG. 5, example operations are shown for performing a group fund transaction.

As shown by operation 502, the apparatus 200 may include means, such as processor 202, memory 204, communications hardware 206, group management circuitry 208, or the like, for determining group fund transaction options for one or more group members. In some embodiments, group fund transaction options may control various transaction parameters for a group funding transaction. For example, group fund transaction options may include a set of authorized payment transaction types, a set of approved funding accounts, a one-time fund transaction amount limit, a daily total fund transaction amount limit, a daily fund transaction frequency limits, or the like. The determination of group fund transaction options will be described in more detail in connection with FIG. 6A.

Turning to FIG. 6A, example operations are shown for determining group fund transaction options for one or more group members. As shown by operation 602, the apparatus 200 may include means, such as processor 202, memory 204, communications hardware 206, group management circuitry 208, or the like, for determining the group fund transaction options available for the ad hoc group. The group fund transaction options may include a set of authorized payment transaction types, a set of approved funding accounts, a one-time fund transaction amount limit, a daily total fund transaction amount limit, a daily fund transaction frequency limit, and/or the like. The group management circuitry 208 may determine some of the group fund transaction options available for the ad hoc group by checking the group fund transaction requirements with a merchant (e.g., a set of authorized payment transaction types, a set of approved funding accounts, etc.). In some embodiments, one or more devices associated with merchants may join the ad hoc group to assist the group fund transaction. For example, some merchants may not accept credit card payment methods and some merchants may only accept payments using smart mobile wallet. In some embodiments, the group management circuitry 208 may select one or more payment methods that provide discounts to group members for the products or services offered by the merchant.

As shown by operation 604, the apparatus 200 may include means, such as processor 202, memory 204, communications hardware 206, or the like, for causing transmission of a group fund transaction options selection request to the one or more group members. After determining the group fund transaction options available for the ad hoc group by the group management circuitry 208, the communications hardware 206 transmit a group fund transaction options selection request with the available group fund transaction options to the one or more group members. The devices associated with the one or more group members (e.g., ad hoc group primary member device 106A-106N and/or the ad hoc group minor member device 108A-108N) may automatically select the group fund transaction options based on the highest payment preference set by the one or more group members. In some embodiments, the available group fund transaction options may be displayed on the devices associated with the one or more group members (e.g., ad hoc group primary member device 106A-106N and/or the ad hoc group minor member device 108A-108N) to allow the one or more group members to manually select the group fund transaction options.

As shown by operation 606, the apparatus 200 may include means, such as processor 202, memory 204, communications hardware 206, or the like, for receiving selected group fund transaction options from the one or more group members.

Finally, as shown by operation 608, the apparatus 200 may include means, such as processor 202, memory 204, communications hardware 206, group management circuitry 208, or the like, for determining the group fund transaction options based on the selected group fund transaction options received from the one or more group members. In some embodiments, the group management circuitry 208 may perform a verification operation on the selected group fund transaction options received from the one or more group members. The communications hardware 206 may cause transmission of a confirmation if the verification operation indicates that the selected group fund transaction options are valid, or a request to reselect from the group fund transaction options if the verification operation indicates that any of the selected group fund transaction options are invalid.

Returning now to FIG. 5, as shown by operation 504, the apparatus 200 may include means, such as processor 202, memory 204, communications hardware 206, group management circuitry 208, payment processing circuitry 212, or the like, for generating a group fund transaction event within the ad hoc group. A group fund transaction event may be a transaction that includes one or more group members and their respective devices. The generation of a group fund transaction event within the ad hoc group will be described in greater detail below in connection with FIG. 6B.

Turning next to FIG. 6B, example operations are shown for generating a group fund transaction event within the ad hoc group. As shown by operation 612, the apparatus 200 may include means, such as processor 202, memory 204, communications hardware 206, or the like, for causing transmission of a pre-transaction notification. The pre-transaction notification may be generated before the group fund transaction. In some embodiments, the pre-transaction notification may be displayed on the devices associated with the one or more group members (e.g., ad hoc group primary member device 106A-106N and/or the ad hoc group minor member device 108A-108N) to alert the one or more group members that a group fund transaction is about to start. The pre-transaction notification may be further used as a timestamp for the group fund transaction for an auditing process.

As shown by operation 614, the apparatus 200 may include means, such as processor 202, memory 204, communications hardware 206, group management circuitry 208, payment processing circuitry 212, or the like, for executing a first group fund transaction for the one or more group members. The group management circuitry 208 may collect funds based on the group fund transaction options selected by the one or more group members by leveraging the payment processing circuitry 212. Then, the payment processing circuitry 212 may further transfer the funds to a merchant to complete a purchase. In some embodiments, the group management circuitry 208 may authorize the payment processing circuitry 212 to transfer funds to a merchant directly for each one or more group members.

As shown by operation 616, the apparatus 200 may include means, such as processor 202, memory 204, communications hardware 206, group management circuitry 208, payment processing circuitry 212, or the like, for causing transmission of a post-first-transaction notification indicating whether the first group fund transaction is successful. The payment processing circuitry 212 may determine if the fund transfer for each one or more group members is successful and notify the group management circuitry 208. Then, the group management circuitry 208 may further transmit a post-first-transaction notification to the one or more group members through the communications hardware 206.

As shown by operation 618, the apparatus 200 may include means, such as processor 202, memory 204, communications hardware 206, group management circuitry 208, payment processing circuitry 212, or the like, for causing transmission of a one-time request to modify the group fund transaction options if the first group fund transaction is not successful for one or more group members. The devices associated with the one or more group members (e.g., ad hoc group primary member device 106A-106N and/or the ad hoc group minor member device 108A-108N) may automatically select the group fund transaction options based on the second highest payment preference set by the one or more group members. In some embodiments, the one-time request to modify the group fund transaction options may be displayed on the devices associated with the one or more group members (e.g., ad hoc group primary member device 106A-106N and/or the ad hoc group minor member device 108A-108N) to allow the one or more group members to manually select different group fund transaction options. The group management circuitry 208 may further receive the different group fund transaction options selected by the one or more group members.

As shown by operation 620, the apparatus 200 may include means, such as processor 202, memory 204, communications hardware 206, group management circuitry 208, payment processing circuitry 212, or the like, for executing a second group fund transaction for the one or more group members. The group management circuitry 208 may collect funds based on the different group fund transaction options selected by the one or more group members by leveraging the payment processing circuitry 212. Then, the payment processing circuitry 212 may further transfer the funds to a merchant for purchase. In some embodiments, the group management circuitry 208 may authorize the payment processing circuitry 212 to transfer funds to a merchant directly for each one or more group members.

As shown by operation 622, the apparatus 200 may include means, such as processor 202, memory 204, communications hardware 206, group management circuitry 208, payment processing circuitry 212, or the like, for causing transmission of a post-second-transaction notification indicating whether the second group fund transaction is successful. The payment processing circuitry 212 may determine if the second fund transfer for each one or more group member is successful and notify the group management circuitry 208. The group management circuitry 208 may further transmit a post-second-transaction notification to the one or more group members through the communications hardware 206.

Finally, as shown by operation 624, the apparatus 200 may include means, such as processor 202, memory 204, communications hardware 206, group management circuitry 208, or the like, for removing one or more group members if the second group fund transaction is not successful. The group management circuitry 208 may provide a notification with a reason to the one or more group members being removed from the ad hoc group through the communications hardware 206. In some embodiments, the group management circuitry 208 may provide one or more chances for the one or more group members to modify the group fund transaction options if the second group fund transaction is not successful.

Returning now to FIG. 5, as shown by operation 506, the apparatus 200 may include means, such as processor 202, memory 204, communications hardware 206, payment processing circuitry 212, or the like, for causing completion of a transaction based on the group fund transaction event. Once the group fund transaction event is successfully completed, the payment processing circuitry 212 may perform one transaction with the merchant for the entire group and obtain a payment confirmation. In some embodiments, the payment processing circuitry 212 may perform one transaction for each group member with the merchant, thus, a payment confirmation for each group member may be obtained.

Finally, as shown by operation 508, the apparatus 200 may include means, such as processor 202, memory 204, communications hardware 206, group management circuitry 208, or the like, for providing indicia of completion of the transaction to the one or more group members. The underlying mechanism for providing indicia of completion of the transaction to the one or more group members will be described in greater detail below in connection with FIG. 6C.

Turning next to FIG. 6C, example operations are shown for providing indicia of completion of the transaction to the one or more group members. As shown by operation 626, the apparatus 200 may include means, such as processor 202, memory 204, communications hardware 206, group management circuitry 208, payment processing circuitry 212, or the like, for receiving from a merchant of the transaction a payment transaction confirmation for the ad hoc group. The payment processing circuitry 212 may receive a payment transaction confirmation for the entire ad hoc group if one payment is made to the merchant. In some embodiments, the payment processing circuitry 212 may receive a payment transaction confirmation for each one or more group members if the payment processing circuitry 212 transfer funds from each one or more group members to the merchant directly. The payment processing circuitry 212 may further provide the confirmation to the group management circuitry 208.

As shown by operation 628, the apparatus 200 may include means, such as processor 202, memory 204, communications hardware 206, group management circuitry 208, payment processing circuitry 212, or the like, for generating itemized indicia of the payment for the one or more group members. The group management circuitry 208 may generate the itemized indicia which may include the purchased items, transaction time, transaction amount, payment method, and merchant name/phone number/address by leveraging the payment processing circuitry 212.

As shown by operation 630, the apparatus 200 may include means, such as processor 202, memory 204, communications hardware 206, or the like, for causing transmission of the itemized indicia to the one or more group members.

Finally, as shown by operation 632, the apparatus 200 may include means, such as processor 202, memory 204, communications hardware 206, group management circuitry 208, or the like, for initiating an audit process if a transaction discrepancy is identified for the one or more group members. After the devices associated with the one or more group members (e.g., ad hoc group primary member device 106A-106N and/or the ad hoc group minor member device 108A-108N) receiving the itemized indicia, the devices associated with the one or more group members may perform automatic check to verify each item listed in the itemized indicia (e.g., purchased items, transaction time, transaction amount, payment method, and merchant name/phone number/address, etc.). When a discrepancy is identified, the devices associated with the one or more group members may send a request to the ad hoc group organizer system 102 to initiate an audit process for further investigation. The one or more group members may be alerted for the discrepancy and the initiation of the audit process through the user interface circuitry 312 (as shown in FIG. 3).

### Example Ad Hoc Group Member Operations

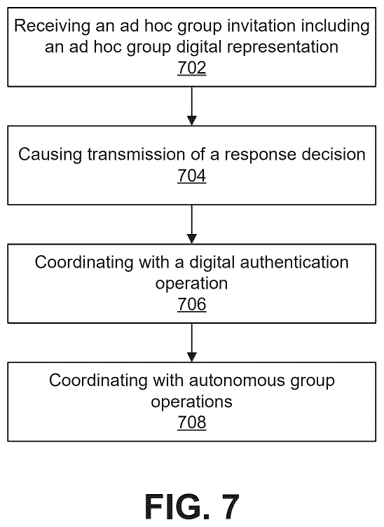

Meanwhile, the various operations described in connection with FIGS. 7, 8, and 9A-9C may be performed by apparatus 300, which may utilize one or more of processor 302, memory 304, communications hardware 306, group coordination circuitry 308, member geolocation circuitry 310, user interface circuitry 312, and/or any combination thereof.

Turning now to FIG. 7, example operations are shown for autonomous ad hoc group operations by the member devices (e.g., ad hoc group primary member devices 106A-106N and/or ad hoc group minor member devices 108A-108N).

As shown by operation 702, the apparatus 300 may include means, such as processor 302, memory 304, communications hardware 306, group coordination circuitry 308, member geolocation circuitry 310, or the like, for receiving an ad hoc group invitation including an ad hoc group digital representation. The ad hoc group digital representation may be one of a text message, an interactive image, a URL, a web page, or a QR code. The individuals receiving the ad hoc group notification may review the ad hoc group information by operating the digital representation (e.g., scanning the QR code, clicking the URL) for making a decision. In some embodiments, before receiving an invitation to join the ad hoc group, individuals may know in advance about the ad hoc group for a future event and may use the devices to pre-register the ad hoc group. The invitations may be received by individuals within an invitation region by leveraging the member geolocation circuitry 310 or may be received by individuals who have pre-registered the ad hoc group.

As shown by operation 704, the apparatus 300 may include means, such as processor 302, memory 304, communications hardware 306, or the like, for causing transmission of a response decision whether to accept or reject the invitation. In some embodiments, the individual may defer the response until a later time. As such, the individual may be offered the flexibility of joining the ad hoc group at any time.

As shown by operation 706, the apparatus 300 may include means, such as processor 302, memory 304, communications hardware 306, group coordination circuitry 308, or the like, for coordinating with a digital authentication operation. The digital authentication operation may be performed by using an mDL stored in the device associated with the individual who accepts the invitation, wherein the mDL comprises either a digital identification for a corresponding primary individual or a digital identification of a guardian linked with a corresponding minor individual. The group coordination circuitry 308 may retrieve the required information on the mDL (e.g., name, age, address, mDL issuing date, mDL expiration date, etc.) based on a request from the ad hoc group organizer system 102 and provide the required information to the ad hoc group organizer system 102. In some embodiments, the group coordination circuitry 308 may authorize the ad hoc group organizer system 102 to access the mDL information directly. In some embodiments, the mDL may be stored in a smart mobile wallet and the group coordination circuitry 308 may further authorize the ad hoc group organizer system 102 to access the personal information stored in the smart mobile wallet and make comparison with the information obtained from the mDL. The group coordination circuitry 308 may receive a verification confirmation or a verification failure (e.g., the mDL is expired, the name is different, etc.) from the ad hoc group organizer system 102.

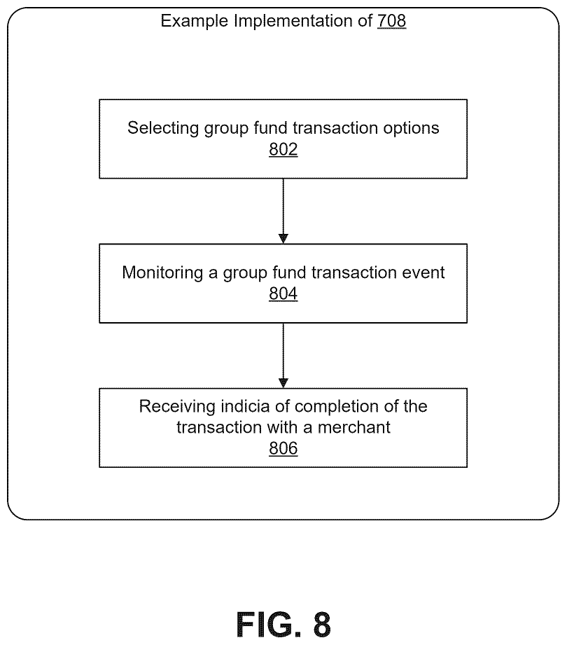

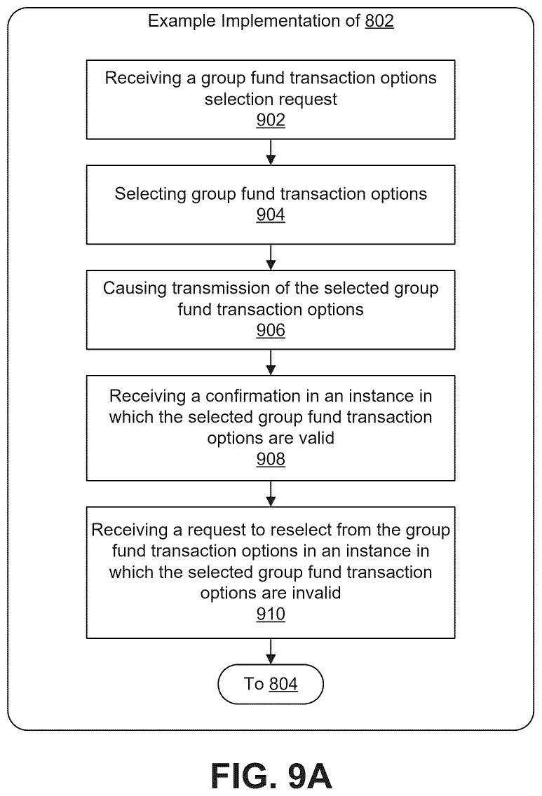

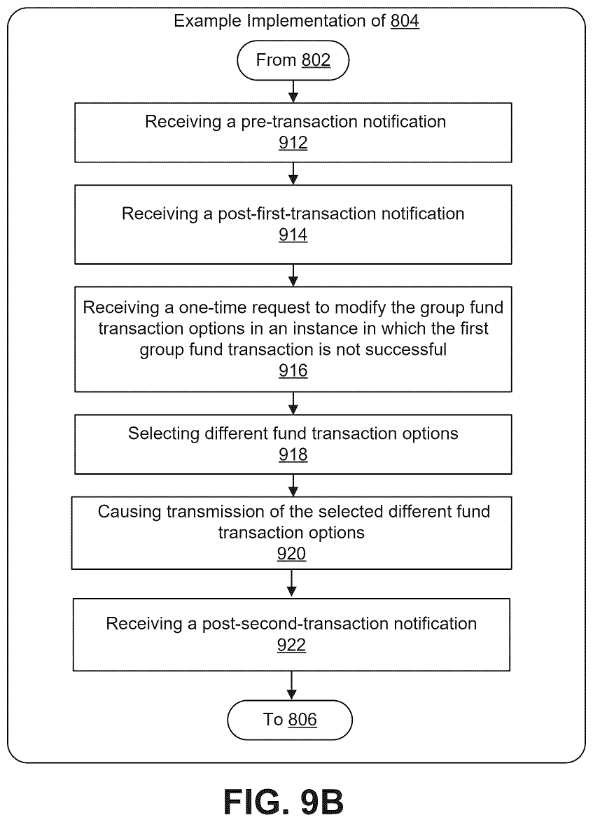

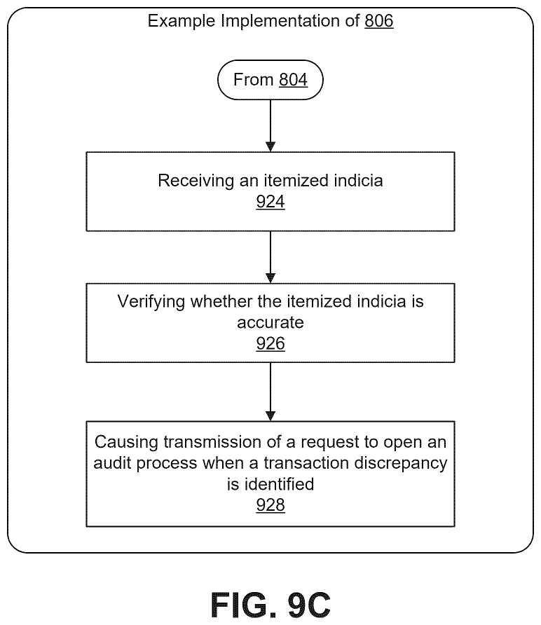

Finally, as shown by operation 708, the apparatus 300 may include means, such as processor 302, memory 304, communications hardware 306, group coordination circuitry 308, member geolocation circuitry 310, user interface circuitry 312, or the like, for coordinating with autonomous group operations. The autonomous group operations may comprise at least one or more of a group message broadcast, a group fund transaction, a group member geolocation tracking, a group member request handling, or a group feedback collection. For group message broadcast, the group coordination circuitry 308 may receive the group message through communications hardware 306 and display the message through the user interface circuitry 312. For group member geolocation tracking, the group coordination circuitry 308 may receive a request for geolocation data randomly or periodically through the communications hardware 306 and then instruct the member geolocation circuitry 310 to provide the geolocation data. Then the group coordination circuitry 308 may further transmit the geolocation data to the ad hoc group organizer system 102 through the communications hardware 306. For group member request handling, a group member may input a request through the user interface circuitry 312. The group coordination circuitry 308 may further transmit the request to the ad hoc group organizer system 102 through the communications hardware 306. For group feedback collection (e.g., after the group event), the group coordination circuitry 308 may receive a request from the ad hoc group organizer system 102 to provide feedback. The group coordination circuitry 308 may further prompt the respective group member to enter the feedback through the user interface circuitry 312. Then, the group coordination circuitry 308 may transmit the feedback to the ad hoc group organizer system 102 through the communications hardware 306. A group fund transaction may be more complicated than those group operations described above and the underlying mechanism for implementing operation 708 for the group fund transaction will be described in greater detail below in connection with FIGS. 8, and 9A-9C.

In some embodiments, operation 708 for a group fund transaction may be performed in accordance with the operations described by FIG. 8. Turning now to FIG. 8, example operations are shown for performing a group fund transaction.

As shown by operation 802, the apparatus 300 may include means, such as processor 302, memory 304, communications hardware 306, group coordination circuitry 308, user interface circuitry 312, or the like, for selecting group fund transaction options. Selectionof group fund transaction options will be described in greater detail below in connection with FIG. 9A.

Turning next to FIG. 9A, example operations are shown for selecting group fund transaction options.

As shown by operation 902, the apparatus 300 may include means, such as processor 302, memory 304, communications hardware 306, user interface circuitry 312, or the like, for receiving a group fund transaction options selection request from the ad hoc group organizer system 102.

As shown by operation 904, the apparatus 300 may include means, such as processor 302, memory 304, communications hardware 306, group coordination circuitry 308, user interface circuitry 312, or the like, for selecting group fund transaction options. The group fund transaction options comprise at least one or more of a set of authorized payment transaction types, a set of approved funding accounts, a one-time fund transaction amount limit, a daily total fund transaction amount limit, or a daily fund transaction frequency limit. After receiving the group fund transaction options selection request by the communications hardware 306, the group coordination circuitry 308 may automatically select the group fund transaction options based on the highest payment preference set by the respective group member. In some embodiments, the group coordination circuitry 308 may display the available group fund transaction options through the user interface circuitry 312 to allow the respective group member to manually select the group fund transaction options. In some embodiments, the group coordination circuitry 308 associated with primary group member and the group coordination circuitry 308 associated with minor group member may operate differently. For example, only the group coordination circuitry 308 associated with primary group member may allow the respective primary group members to manually select the group fund transaction options though the user interface circuitry 312.

As shown by operation 906, the apparatus 300 may include means, such as processor 302, memory 304, communications hardware 306, or the like, for causing transmission of the selected group fund transaction options to the ad hoc group organizer system 102.

As shown by operation 908, the apparatus 300 may include means, such as processor 302, memory 304, communications hardware 306, group coordination circuitry 308, user interface circuitry 312, or the like, for receiving a confirmation if the selected group fund transaction options are valid. In some embodiments, after receiving the confirmation through the communications hardware 306, the group coordination circuitry 308 may display the confirmation to notify the respective group member through the user interface circuitry 312.

Finally, as shown by operation 910, the apparatus 300 may include means, such as processor 302, memory 304, communications hardware 306, group coordination circuitry 308, user interface circuitry 312, or the like, for receiving a request to reselect from the group fund transaction options if the selected group fund transaction options are invalid. After receiving the request to reselect from the group fund transaction options through the communications hardware 306, the group coordination circuitry 308 may automatically select the group fund transaction options based on the next highest payment preference set by the respective group members. In some embodiments, the group coordination circuitry 308 may display the request to reselect from the group fund transaction options through the user interface circuitry 312 to allow the respective group member to manually select different group fund transaction options. In some embodiments, the group coordination circuitry 308 associated with primary group members and the group coordination circuitry 308 associated with minor group member may operate differently. For example, only the group coordination circuitry 308 associated with primary group member may allow the respective primary group members to manually select different group fund transaction options though the user interface circuitry 312.

Returning now to FIG. 8, as shown by operation 804, the apparatus 300 may include means, such as processor 302, memory 304, communications hardware 306, group coordination circuitry 308, user interface circuitry 312, or the like, for monitoring a group fund transaction event. Monitoring a group fund transaction event will be described in greater detail below in connection with FIG. 9B.

Turning next to FIG. 9B, example operations are shown for monitoring a group fund transaction event. As shown by operation 912, the apparatus 300 may include means, such as processor 302, memory 304, communications hardware 306, group coordination circuitry 308, user interface circuitry 312, or the like, for receiving a pre-transaction notification from the ad hoc group organizer system 102. The communications hardware 306 may receive the pre-transaction notification before the first group fund transaction. After receiving the pre-transaction notification, the group coordination circuitry 308 may display the notification to alert the respective group member through the user interface circuitry 312. The group coordination circuitry 308 may further prepare for the fund transfer by securely enabling the fund transfer and authorizing the ad hoc group organizer system 102 to retrieve fund using the selected group fund transaction options.

As shown by operation 914, the apparatus 300 may include means, such as processor 302, memory 304, communications hardware 306, group coordination circuitry 308, user interface circuitry 312, or the like, for receiving a post-first-transaction notification from the ad hoc group organizer system 102. The communications hardware 306 may receive the post-first- transaction notification after the first group fund transaction. The notification may indicate if the first group fund transaction is successful or not. After receiving the pre-transaction notification, the group coordination circuitry 308 may display the notification to alert the respective group member through the user interface circuitry 312. The group coordination circuitry 308 may further disable fund transfer by securely closing the fund transfer using the selected group fund transaction options.

As shown by operation 916, the apparatus 300 may include means, such as processor 302, memory 304, communications hardware 306, group coordination circuitry 308, user interface circuitry 312, or the like, for receiving a one-time request to modify the group fund transaction options from the ad hoc group organizer system 102. After receiving the one-time request to modify the group fund transaction options, the group coordination circuitry 308 may display the notification to alert the respective group member through the user interface circuitry 312.

As shown by operation 918, the apparatus 300 may include means, such as processor 302, memory 304, communications hardware 306, group coordination circuitry 308, user interface circuitry 312, or the like, for selecting different fund transaction options. After receiving the one-time request to modify the group fund transaction options by the communications hardware 306, the group coordination circuitry 308 may automatically select the group fund transaction options based on the next highest payment preference set by the respective group members. In some embodiments, the group coordination circuitry 308 may display the one-time request to modify the group fund transaction options through the user interface circuitry 312 to allow the respective group member to manually select different group fund transaction options. In some embodiments, the group coordination circuitry 308 associated with primary group member and the group coordination circuitry 308 associated with minor group member may operate differently. For example, only the group coordination circuitry 308 associated with primary group member may allow the respective primary group member to manually select different group fund transaction options through the user interface circuitry 312.

As shown by operation 920, the apparatus 300 may include means, such as processor 302, memory 304, communications hardware 306, or the like, for causing transmission of the selected different fund transaction options to the ad hoc group organizer system 102. The group coordination circuitry 308 may further prepare for the second group fund transaction by securely enabling the fund transfer and authorizing the ad hoc group organizer system 102 to retrieve fund using the selected different group fund transaction options.

Finally, as shown by operation 922, the apparatus 300 may include means, such as processor 302, memory 304, communications hardware 306, group coordination circuitry 308, user interface circuitry 312, or the like, for receiving a post-second-transaction notification from the ad hoc group organizer system 102. The communications hardware 306 may receive the post-second-transaction notification after the second group fund transaction. The notification may indicate if the second group fund transaction is successful or not. After receiving the post-second-transaction notification, the group coordination circuitry 308 may display the notification to alert the respective group member through the user interface circuitry 312. The group coordination circuitry 308 may further disable fund transfer by securely closing the fund transfer using the selected different group fund transaction options. The group coordination circuitry 308 may further receive a notification of being removed from the ad hoc group through the communications hardware 306 if the second group fund transaction also failed.

Returning now to FIG. 8, finally, as shown by operation 806, the apparatus 300 may include means, such as processor 302, memory 304, communications hardware 306, group coordination circuitry 308, or the like, for receiving indicia of completion of the transaction. Receiving indicia indicative of the completion of the transaction will be described in greater detail below in connection with FIG. 9C.

Turning next to FIG. 9C, example operations are shown for receiving indicia of completion of the transaction with a merchant. As shown by operation 924, the apparatus 300 may include means, such as processor 302, memory 304, communications hardware 306, group coordination circuitry 308, user interface circuitry 312, or the like, for receiving an itemized indicia for the transaction with a merchant. The itemized indicia may include purchased items, transaction time, transaction amount, payment method, and merchant name/phone number/address.

As shown by operation 926, the apparatus 300 may include means, such as processor 302, memory 304, communications hardware 306, group coordination circuitry 308, user interface circuitry 312, or the like, for verifying whether the itemized indicia are accurate. The group coordination circuitry 308 may verify the itemized indicia by comparing each item with a saved transaction history record. In some embodiments, the group coordination circuitry 308 may display the itemized indicia to allow the respective group member to manually examine whether the itemized indicia are accurate.

Finally, as shown by operation 928, the apparatus 300 may include means, such as processor 302, memory 304, communications hardware 306, group coordination circuitry 308, user interface circuitry 312, or the like, for causing transmission of a request to open an audit process when a transaction discrepancy is identified. When a transaction discrepancy (e.g., the amount is not correct, the purchased item is not correct, etc.) is identified, the group coordination circuitry 308 may send a request to the ad hoc group organizer system 102 to initiate an audit process for further investigations. The group coordination circuitry 308 may alert the respective group member for the transaction discrepancy and the initiation of the audit process through the user interface circuitry 312. In some embodiments, the group coordination circuitry 308 associated with a minor group member may further notify the guardian linked with the minor group member for the transaction discrepancy and the initiation of the audit process.

FIGS. 4-9C illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

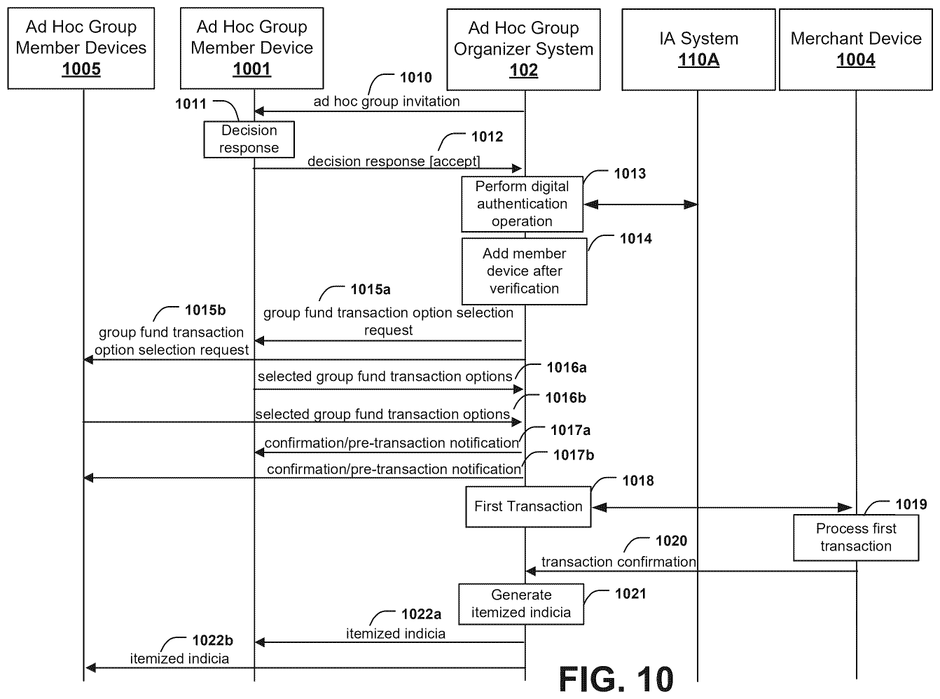

FIG. 10 shows a swim lane diagram illustrating example operations (e.g., as described above in connection with FIGS. 4-9C) performed by components of the environment depicted in FIG. 1 to produce various benefits of the implementations described herein. The operations shown in the swim lane diagram performed by an ad-hoc group member device (e.g., ad hoc group primary member device 106A-106N and/or the ad hoc group minor member device 108A-108N) are shown along the line extending from the box labeled “Ad Hoc Group Member Device 1001,” operations performed by other ad-hoc group member devices (e.g., ad hoc group primary member device 106A-106N and/or the ad hoc group minor member device 108A-108N) are shown along the line extending from the box labeled “Ad Hoc Group Member Devices 1005,” operations performed by the ad hoc group organizer system (e.g., ad hoc group organizer system 102) are shown along the line extending from the box labeled “Ad Hoc Group Organizer System 102,” operations performed by an IA system (e.g., IA system 110A-110N) are shown along the line extending from the box labeled “IA System 110A,” and operations performed by a merchant device are shown along the line extending from the box labeled “Merchant Device 1004”. Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 10.

At operation 1010, the ad hoc group organizer system 102 sends an ad hoc group invitation to a “potential” ad hoc group member device 1001 (i.e., before joining an ad hoc group) located in an invitation region. The ad hoc group invitation includes an ad hoc group digital representation (e.g., a text message, an interactive image, a URL, a web page, or a QR code, etc.).

At operation 1011, the ad hoc group member device 1001 receives input from the user indicative of a response decision. At operation 1012, the ad hoc group member device 1001 provides the decision response to the ad hoc group organizer system 102 using the ad hoc group digital representation to accept, reject or defer joining the ad hoc group. Here, the ad hoc group member device 1001 may provide a decision response of accept.

At operation 1013, the ad hoc group organizer system 102 performs a digital authentication operation using the IA system 110A to authenticate the ad hoc group member device 1001 which have accepted the ad hoc group invitation. At operation 1014, in an instance in which the ad hoc group member device 1001 is successfully authenticated, the ad hoc group organizer system may add the as hoc group member device 1001 to the ad hoc group.

At operations 1015a and 1015b, the ad hoc group organizer system 102 sends a group fund transaction option selection request to the ad hoc group member device 1001 and other group member devices currently in the ad hoc group (e.g., ad hoc group member devices 1005), respectively. At operations 1016a and 1016b, the ad hoc group member device 1001 and ad hoc group member devices 1005 send selected group fund transaction options to the ad hoc group organizer system 102.

At operations 1017a and 1017b, the ad hoc group organizer system 102 sends a confirmation and a pre-transaction notification to the ad hoc group member device 1001 and other ad hoc group member devices 1005, indicating that the selected group fund transaction options are valid, and a group fund transaction event is about to start.

At operation 1018 the ad hoc group organizer system 102 executes a first group fund transaction with the merchant device 1004.

At operation 1019, the merchant device 1004 processes the payment transaction request from the ad hoc group organizer system 102. At operation 1020, the merchant device 1004 sends a transaction confirmation to the ad hoc group organizer system 102.

At operation 1021, the ad hoc group organizer system 102 generates itemized indicia for the transaction for each group member. The itemized indicia may include the purchased items, transaction time, transaction amount, payment method, and merchant name/phone number/address. Finally, at operations 1022a and 1022b, the ad hoc group organizer system 102 sends the itemized indicia of the transaction to respective member devices, ad hoc group member device 1001 and ad hoc group member devices 1005.

In some embodiments, some of the operations described above in connection with FIGS. 4-9C may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable autonomous ad hoc group operations. The example embodiments are capable of establishing an ad hoc group automatically regardless of the size of the group and modifying the ad hoc group at any time with minimal human intervention. Moreover, the example embodiments are capable of performing all ad hoc group operations autonomously, which ensures real-time and accurate operations at the venue. Finally, the example embodiments provide great flexibility and high security to the ad hoc group by avoiding human errors, which may significantly reduce fraud, disputes and serious safety concerns, especially for ad hoc groups including young children and elders.

As these examples all illustrate, example embodiments contemplated herein provide technical solutions that solve real-world problems faced with managing a large size of group for decades. Example embodiments described herein allow for management and operation of ad hoc groups that consider individuals fast-pacing modern lifestyles and constantly changing schedules. For example, example embodiments eliminate the time-consuming tasks of pre-planning such ad hoc group operations and further, simplify operations for group members.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for establishing an ad hoc group, the method comprising:
creating, by group management circuitry, an ad hoc group digital representation;
selecting, by organizer geolocation circuitry, an invitation region;
causing transmission, by communications hardware, of an ad hoc group invitation to one or more devices associated with individuals within the invitation region, wherein the ad hoc group invitation includes the ad hoc group digital representation;
receiving, by the communications hardware, response decisions from the one or more devices associated with the individuals within the invitation region;
performing, by identity verification circuitry, a digital authentication operation to authenticate the one or more devices for which the response decisions indicate acceptance of the ad hoc group invitation;
adding, by user interface circuitry, authenticated devices to the ad hoc group; and
performing, by the group management circuitry, autonomous group operations.

2. The method of claim 1, wherein the ad hoc group digital representation is one of a text message, an interactive image, a uniform resource locator (URL), a web page, or a quick response (QR) code.

3. The method of claim 1, wherein the digital authentication operation uses a mobile drive license (mDL) associated with the one or more devices, wherein the mDL associated with each of the one or more devices comprises either a digital identification for a corresponding primary individual or a digital identification of a guardian individual linked with a corresponding minor individual.

4. The method of claim 1, wherein the autonomous group operations comprise at least one or more of a group message broadcast, a group fund transaction, a group member geolocation tracking, a group member request handling, or a group feedback collection.

5. The method of claim 4, wherein performing the group fund transaction comprises:
determining, by the group management circuitry, group fund transaction options for one or more group members;
generating, by the group management circuitry, a group fund transaction event within the ad hoc group;
causing, by payment processing circuitry, completion of a transaction based on the group fund transaction event; and
providing, by the group management circuitry, indicia of the completion of the transaction to the one or more group members.

6. The method of claim 5, wherein the group fund transaction options comprise at least one or more of a set of authorized payment transaction types, a set of approved funding accounts, a one-time fund transaction amount limit, a daily total fund transaction amount limit, or a daily fund transaction frequency limit.

7. The method of claim 5, wherein determining the group fund transaction options of the one or more group members further comprises:
determining, by the group management circuitry, the group fund transaction options available for the ad hoc group;
causing transmission, by the communications hardware, of a group fund transaction options selection request to the one or more group members;
receiving, by the communications hardware, selected group fund transaction options from the one or more group members; and
determining, by the group management circuitry, the group fund transaction options based on the selected group fund transaction options received from the one or more group members.

8. The method of claim 7, wherein determining the group fund transaction options of the one or more group members further comprises:
performing, by the group management circuitry, a verification operation on the selected group fund transaction options received from the one or more group members;
in an instance in which the verification operation indicates that the selected group fund transaction options are valid, causing transmission, by the communications hardware, of a confirmation; and
in an instance in which the verification operation indicates that any of the selected group fund transaction options are invalid, causing transmission, by the communications hardware, of a request to reselect from the group fund transaction options.

9. The method of claim 5, wherein generating the group fund transaction event within the ad hoc group further comprises:
causing transmission to the one or more group members, by the communications hardware, of a pre-transaction notification;
executing, by the group management circuitry, a first group fund transaction for the one or more group members; and
causing transmission to the one or more group members, by the communications hardware, of a post-first-transaction notification indicating whether the first group fund transaction is successful.

10. The method of claim 9, wherein generating the group fund transaction event within the ad hoc group further comprises:
in an instance in which the first group fund transaction is not successful, causing transmission, by the communications hardware to the one or more group members, a one-time request to modify the group fund transaction options;
executing, by the group management circuitry, a second group fund transaction for the one or more group members;
causing transmission, by the communications hardware to the one or more group members, of a post-second-transaction notification indicating whether the second group fund transaction is successful; and
in an instance in which the second group fund transaction is not successful, removing, by the group management circuitry, one or more of the one or more group members from the ad hoc group.

11. The method of claim 5, wherein providing the indicia of the transaction to the one or more group members further comprises:
receiving from a merchant of the transaction, by the communications hardware, a payment transaction confirmation for the ad hoc group;
generating, by the group management circuitry, itemized indicia for the one or more group members;
cause transmission, by the communications hardware, of the itemized indicia to the one or more group members; and
initiating, by the group management circuitry, an audit process in an instance in which a transaction discrepancy is identified for the one or more group members.

12. An apparatus for establishing an ad hoc group, the apparatus comprising:
group management circuitry configured to create an ad hoc group digital representation;
organizer geolocation circuitry configured to select an invitation region;
communications hardware configured to:
cause transmission of an ad hoc group invitation to one or more devices associated with individuals within the invitation region, wherein the ad hoc group invitation includes the ad hoc group digital representation, and
receive response decisions from the one or more devices associated with the individuals within the invitation region;
identity verification circuitry configured to perform a digital authentication operation to authenticate the one or more devices for which the response decisions indicate acceptance of the ad hoc group invitation; and
user interface circuitry configured to add authenticated devices to the ad hoc group,
wherein the group management circuitry is further configured to perform autonomous group operations.

13. The apparatus of claim 12, wherein the group management circuitry is further configured to:
determine group fund transaction options for one or more group members, and
generate a group fund transaction event within the ad hoc group,
wherein the apparatus further comprises payment processing circuitry configured to cause completion of a transaction based on the group fund transaction event; and
wherein the group management circuitry is further configured to provide indicia of the completion of the transaction to the one or more group members.

14. The apparatus of claim 13, wherein the group management circuitry is further configured to determine the group fund transaction options available for the ad hoc group,
wherein the communications hardware is further configured to:
cause transmission of a group fund transaction options selection request to the one or more group members, and
receive selected group fund transaction options from the one or more group members; and
wherein the group management circuitry is further configured to determine the group fund transaction options based on the selected group fund transaction options received from the one or more group members.

15. The apparatus of claim 14, wherein the group management circuitry is further configured to perform a verification operation on the selected group fund transaction options received from the one or more group members; and
wherein the communications hardware is further configured to:
in an instance in which the verification operation indicates that the selected group fund transaction options are valid, cause transmission of a confirmation, and
in an instance in which the verification operation indicates that any of the selected group fund transaction options are invalid, cause transmission of a request to reselect from the group fund transaction options.

16. The apparatus of claim 13, wherein the communications hardware is further configured to cause transmission to the one or more group members of a pre-transaction notification;
wherein the group management circuitry is further configured to execute a first group fund transaction for the one or more group members; and
wherein the communications hardware is further configured to cause transmission to the one or more group members of a post-first-transaction notification whether the first group fund transaction is successful.

17. The apparatus of claim 16, wherein the communications hardware is further configured to cause transmission to the one or more group members a one-time request to modify the group fund transaction options in an instance in which the first group fund transaction is not successful;
wherein the group management circuitry is further configured to execute a second group fund transaction for the one or more group members;
wherein the communications hardware is further configured to cause transmission to the one or more group members of a post-second-transaction notification indicating whether the second group fund transaction is successful; and
wherein the group management circuitry is further configured to remove one or more of the one or more group members from the ad hoc group in an instance the second group fund transaction is not successful.

18. The apparatus of claim 13, wherein the communications hardware is further configured to receive from a merchant of the transaction a payment transaction confirmation for the ad hoc group;
wherein the group management circuitry is further configured to generate itemized indicia for the one or more group members;
wherein the communications hardware is further configured to cause transmission of the itemized indicia to the one or more group members; and
wherein the group management circuitry is further configured to initiate an audit process when a transaction discrepancy is identified for the one or more group members.

19. A computer program product for establishing an ad hoc group, the computer program product comprising at least one non-transitory computer-readable storage medium storing software instructions that, when executed, cause an apparatus to:
create an ad hoc group digital representation;
select an invitation region;
cause transmission of an ad hoc group invitation to one or more devices associated with individuals within the invitation region, wherein the ad hoc group invitation includes the ad hoc group digital representation;
receive response decisions from the one or more devices associated with the individuals within the invitation region;
perform a digital authentication operation to authenticate the one or more devices for which the response decisions indicate acceptance of the ad hoc group invitation;
add authenticated devices to the ad hoc group; and
perform autonomous group operations.

20. The computer program product of claim 19, wherein the software instructions, when executed, further cause the apparatus to:
determine group fund transaction options of one or more group members;
generate a group fund transaction event within the ad hoc group;
cause completion of a transaction based on the group fund transaction event; and
provide indicia of the completion of the transaction to the one or more group members.
